(19) United States
(12) Patent Application Publication
(10) Pub. No.: US 2025/0238740 A1
(43) Pub. Date: Jul. 24, 2025

(54) ORGANIZATION SOURCING SYSTEMS AND METHODS

(71) Applicant: Pillsbury Winthrop Shaw Pittman LLP, New York, NY (US)

(72) Inventors: Joseph E. Nash, Santa Fe, NM (US); Philip T. Evans, Newton, MA (US); Roger C. Roy Jr., Walnut Creek, CA (US); Michael McCann, Navan (IE)

(21) Appl. No.: 19/025,670

(22) Filed: Jan. 16, 2025

Related U.S. Application Data
(60) Provisional application No. 63/623,585, filed on Jan. 22, 2024.

(51) Int. Cl. G06Q 10/0631; G06Q 10/10

(52) U.S. Cl. CPC G06Q 10/06315; G06Q 10/103

(57) ABSTRACT

Provided is a technique that includes determining a scope model including a process-element matrix including a set of processes, a set of elements, and process-element pairs that each correspond to a respective pair of a process of the set of processes and an element of the set of elements, and populating one or more of the process-element pairs of the process-element matrix to identify an actor associated with performing the process associated with the process-element pair for the element associated with the process-element pair, and to identify an attribute associated with the process-element pair.

### RELATED APPLICATIONS

This application claim benefit of and priority to U.S. Provisional Patent Application No. 63/623,585 titled “ORGANIZATION SOURCING SYSTEMS AND METHODS” and filed Jan. 22, 2024, which is herby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments relate generally to managing organizations and more particularly to techniques for assessing, defining, and implementing organizational outsourcing.

### BACKGROUND

Outsourcing refers to the practice of an organization delegating specific business functions or tasks to third-party organizations, such as external companies or service providers, often with the goal of reducing costs, increasing efficiency, or gaining access to specialized expertise. Outsourcing typically involves an organization (often referred to as an “outsourcing client”) contracting out various functions of an organization, such as customer support, information technology, human resources, or manufacturing, to third-party organizations (often referred to as “outsourcing providers”) that specialize in those areas. This can enable outsourcing clients to focus on core competencies while benefiting from an outsourcing provider's expertise and resources.

A large risk in outsourcing is a provider's ability to perform adequately. As a result, it can be important for outsourced items (or “tasks”) to be clearly delegated, in a highly controlled fashion. In many instances, outsourcing clients and providers engage in time-consuming and tedious negotiations to generate statements of work (SOWs) to define responsibilities. A SOW may, for example, be a formal document that outlines specific details of a project, associated tasks, and specifies sets of tasks to be provided by one or more outsourcing providers. A SOW can serve as a foundational document that helps both the client and the outsourcing provider establish a common understanding of a project's parameters and expectations. It can play a crucial role in managing and governing the outsourcing relationship, acting as a blueprint for an entire outsourcing engagement to ensure that the work is performed as agreed upon and in accordance with the client's needs and objectives.

### SUMMARY

Applicants have recognized that creating statements of work (SOWs) for outsourcing projects can present significant challenges, such as defining clear and precise objectives and metrics. Clarity and precision are paramount, as a vague or ambiguous SOW can lead to misunderstandings and disputes down the line. Determining the precise scope of work and defining what is in or out of the scope for each party is a delicate task that typically includes a goal of preventing unintended or unexpected shifts in responsibility over time (or “scope creep”). Crafting measurable objectives and performance metrics that accurately reflect desired outcomes is a challenge in itself, where it is important to establish goals and how parties are measuring up to the goals. The SOW often addresses various legal and compliance issues, such as data protection, intellectual property, and regulatory compliance, which can be complex, particularly in international outsourcing. Managing and mitigating risks in the SOW and specifying resource requirements accurately can be daunting. Furthermore, handling changes, ensuring effective communication and collaboration, establishing service levels, and managing costs can all prove to be challenging aspects of creating SOWs. Developing an exit strategy in case the outsourcing relationship needs to be terminated and addressing cultural and time zone differences in international outsourcing relationships are additional hurdles that organizations may encounter. To address these challenges, it is often necessary to involve legal experts, subject matter experts, and experienced project managers in the SOW creation process. Additionally, ongoing monitoring and management of the outsourcing relationship are necessary to ensure the SOW is effectively implemented, and any issues are promptly addressed.

Provided are embodiments of techniques for assessing, defining, and implementing organizational outsourcing. In some embodiments, organizational outsourcing includes generating a scope model that associates actors and attributes with various processes and elements of an outsourcing project. This may include generating a scope model that includes a process-element matrix, where the process-element matrix defines a set of processes for outsourcing, a set of elements for outsourcing, and process-element pairs that each correspond to a respective pair of a process of the set of processes and an element of the set of elements. Each of one or more of the process-element pairs of the process-element matrix may be populated to identify an actor associated with performing the process associated with the process-element pair for the element associated with the process-element pair, or to identify an attribute associated with the process-element pair.

In some embodiments, an outsourcing process includes the following: (1) receiving a set of scoping parameters defining one or more aspects of an outsourcing project; (2) generating a scope model (defining processes, elements and associated process-element pairs), based on a the set of scoping parameters; (3) generating a set of process and element definitions for the respective processes and elements of the scope model; (4) generating an outsourcing statement of work (SOW) that includes the scope model and the set of process and element definitions; and (5) conducting outsourcing in accordance with the SOW. In some embodiments, the process-element pairs of the scope model are populated with associated actor or attributes associated therewith, such as an indication of a maturity, duration, resource level, or the like associated with the process-element pair. In some embodiments, the scope model is generated based on application of the scoping parameters to a scoping model, which may, for example, be a trained AI-based model. In some embodiments, the set of process and element definitions are generated based on associated process and element definition mappings.

Provided in some embodiments is an outsourcing management system including: a sourcing information database including: a process definition mapping; an element definition mapping; and non-transitory computer readable storage medium including program instructions stored thereon that are executable by a processor to perform the following operations for outsourcing: receiving, from an outsourcing client, scoping parameters; determining, based on the scoping parameters, a scope model including a process-element matrix, the process-element matrix including: a set of processes; a set of elements; and process-element pairs that each correspond to a respective pair of a process of the set of processes and an element of the set of elements, each of one or more of the process-element pairs of the process-element matrix populated to identify an actor associated with performing the process associated with the process-element pair for the element associated with the process-element pair, and to identify an attribute associated with the process-element pair; determining, based on the process definition mapping, a set of process definitions for the set of processes of the scope model; determining, based on the element definition mapping, a set of element definitions for the set of elements of the scope model; and generating an outsourcing statement of work including: the populated scope model; the set of process definitions; and the set of element definitions.

In some embodiments, the attribute includes a maturity of the actor for the process-element pair, a duration for the process-element pair, or a resource level for the process-element pair. In certain embodiments, the database includes attribute mapping, and the attributes associated with the process-element pairs are determined based on the attribute mapping. In some embodiments, the operations further including: receiving monitoring data corresponding to attributes associated with the process-element pairs; and generating, based on the monitoring data, the attribute mapping. In certain embodiments, the database includes a scoping model trained to determine a scope model based on a set of scoping parameters, and determining the scope model includes applying the scoping parameters to the scoping model to determine the scope model. In some embodiments, the operations further including training the scoping model based on historical sets of scoping parameters and associated scope models. In certain embodiments, an outsourcing operation is performed in accordance with the statement of work.

Provided in some embodiments is a method of outsourcing management including: receiving, from an outsourcing client, scoping parameters; determining, based on the scoping parameters, a scope model including a process-element matrix, the process-element matrix including: a set of processes; a set of elements; and process-element pairs that each correspond to a respective pair of a process of the set of processes and an element of the set of elements, each of one or more of the process-element pairs of the process-element matrix populated to identify an actor associated with performing the process associated with the process-element pair for the element associated with the process-element pair, and to identify an attribute associated with the process-element pair; determining, based on a process definition mapping, a set of process definitions for the set of processes of the scope model; determining, based on an element definition mapping, a set of element definitions for the set of elements of the scope model; and generating an outsourcing statement of work including: the populated scope model; the set of process definitions; and the set of element definitions.

In some embodiments, the attribute includes a maturity of the actor for the process-element pair, a duration for the process-element pair, or a resource level for the process-element pair. In certain embodiments, the attributes associated with the process-element pairs are determined based on an attribute mapping. In some embodiments, the method further including: receiving monitoring data corresponding to attributes associated with the process-element pairs; and generating, based on the monitoring data, the attribute mapping. In certain embodiments, determining the scope model includes applying the scoping parameters to a scoping model trained to determine a scope model based on a set of scoping parameters, to determine the scope model. In some embodiments, the method further including training the scoping model based on historical sets of scoping parameters and associated scope models. In certain embodiments, the method further including performing an outsourcing operation in accordance with the statement of work.

Provided in some embodiments is a method including: determining a scope model including a process-element matrix, the process-element matrix including: a set of processes; a set of elements; and process-element pairs that each correspond to a respective pair of a process of the set of processes and an element of the set of elements, and populating one or more of the process-element pairs of the process-element matrix to identify an actor associated with performing the process associated with the process-element pair for the element associated with the process-element pair, and to identify an attribute associated with the process-element pair. In some embodiments, the attribute includes a maturity of the actor for the process-element pair, a duration for the process-element pair, or a resource level for the process-element pair. In certain embodiments, the method further including performing an outsourcing operation based on the scope model. Provided in some embodiments is non-transitory computer readable medium comprising program instructions stored thereon that are executable by a processor to perform any one of the above described methods.

Provided in some embodiments is a scope model including: a process-element matrix, the process-element matrix including: a set of processes; a set of elements; and process-element pairs that each correspond to a respective pair of a process of the set of processes and an element of the set of elements, one or more of the process-element pairs of the process-element matrix being populated to identify an actor associated with performing the process associated with the process-element pair for the element associated with the process-element pair, and to identify an attribute associated with the process-element pair. In some embodiments, the attribute includes a maturity of the actor for the process-element pair, a duration for the process-element pair, or a resource level for the process-element pair.

### BRIEF DESCRIPTION OF THE DRAWINGS

FIG. 1A is a diagram that illustrates an outsourcing environment in accordance with one or more embodiments.

FIG. 1B is a diagram that illustrates various aspects of outsourcing in accordance with one or more embodiments.

FIG. 2 is a diagram that illustrates an example element definition mapping in accordance with one or more embodiments.

FIG. 3 is a diagram that illustrates an example process definition mapping in accordance with one or more embodiments.

FIGS. 4A-4C are diagrams that illustrate example attribute mappings in accordance with one or more embodiments.

FIG. 5A-5C are diagrams that illustrate example scope models in accordance with one or more embodiments.

FIG. 6A-6C are diagrams that illustrate populated scope models of a statement of work (SOW) in accordance with one or more embodiments.

FIG. 7 is a diagram that illustrates an example set of process definitions of a SOW in accordance with one or more embodiments.

FIG. 8 is a diagram that illustrates an example set of element definitions of a SOW in accordance with one or more embodiments.

FIG. 9 is a flowchart diagram that illustrates a method of generating and implementing a scope model in accordance with one or more embodiments.

FIG. 10 is a flowchart diagram that illustrates a method of training and implementing a scoping model in accordance with one or more embodiments.

FIG. 11 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Described are embodiments of techniques for assessing, defining, and implementing organizational outsourcing. In some embodiments, organizational outsourcing includes generating a scope model that associates actors and attributes with various processes and elements of an outsourcing project. This may include generating a scope model that includes a process-element matrix, where the process-element matrix defines a set of processes for outsourcing, a set of elements for outsourcing, and process-element pairs that each correspond to a respective pair of a process of the set of processes and an element of the set of elements. Each of one or more of the process-elements pair of the process-element matrix may be populated to identify an actor associated with performing the process associated with the process-element pair for the element associated with the process-element pair, or to identify an attribute associated with the process-element pair.

In some embodiments, an outsourcing process includes the following: (1) receiving a set of scoping parameters defining one or more aspects of an outsourcing project; (2) generating a scope model (defining processes, elements and associated process-element pairs), based on a the set of scoping parameters; (3) generating a set of process and element definitions for the respective processes and elements of the scope model; (4) generating an outsourcing statement of work (SOW) that includes the scope model and the set of process and element definitions; and (5) conducting outsourcing in accordance with the SOW. In some embodiments, the process-element pairs of the scope model are populated with associated actor or attributes associated therewith, such as an indication of a maturity, duration, resource level, or the like associated with the process-element pair. In some embodiments, the scope model is generated based on application of the scoping parameters to a scoping model, which may, for example, be a trained AI-based model. In some embodiments, the set of process and element definitions are generated based on associated process and element definition mappings. Embodiments provide an improved process for assessing, defining, and implementing organizational outsourcing, which may not be reasonably achievable by traditional methods, such as manual creation and tracking of outsourced operations, which can introduce inaccuracies, unacceptable delays, or the like. For example, embodiments described provide improved systems and method for SOW creation and ongoing monitoring and management of an outsourcing relationship to ensure the SOW is effectively implemented and updated, and any issues are promptly identified and addressed. This can, in turn, significantly enhance the effectiveness and efficiency of outsourcing operations.

Although certain embodiments are described in the context of information technology (IT) infrastructure for the purpose of explanation, embodiments may be directed to any suitable context, such as customer support, manufacturing, finance, or the like.

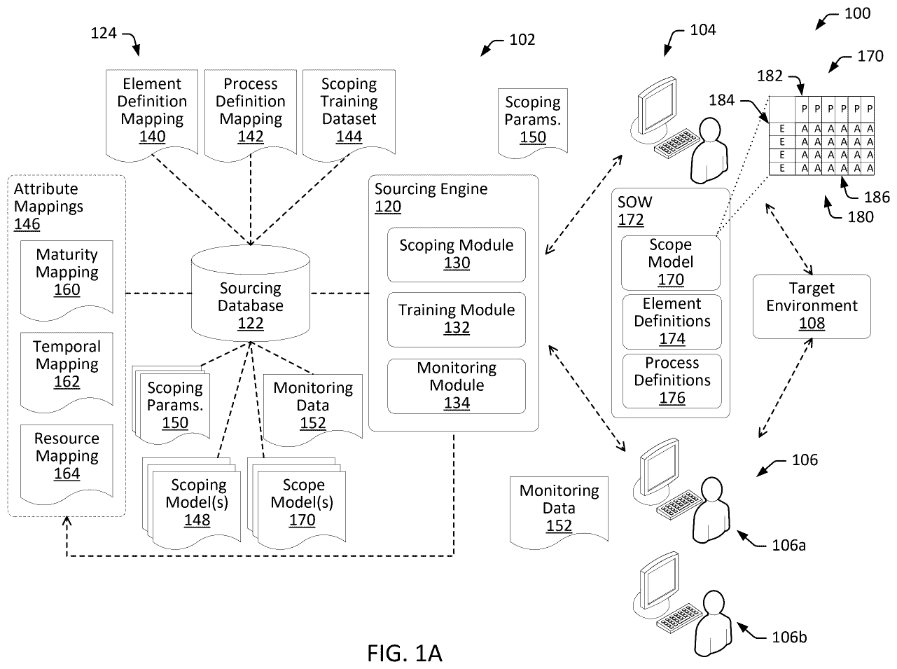

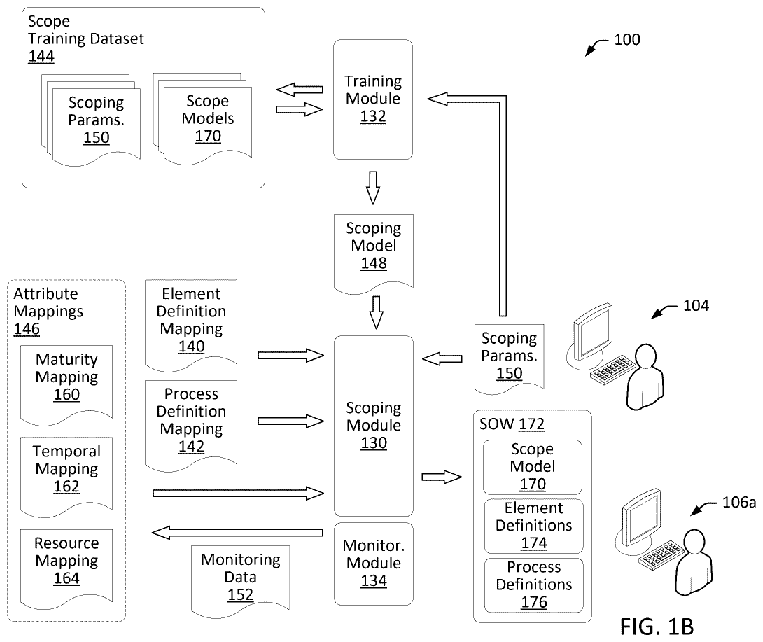

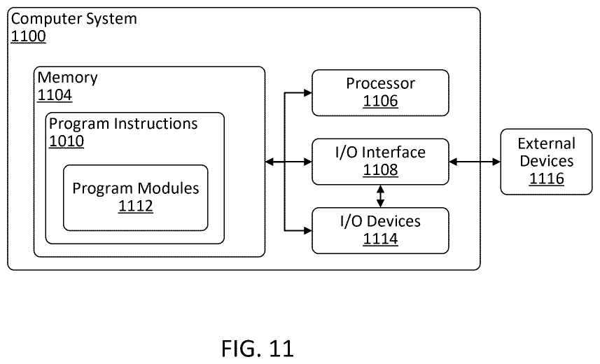

FIG. 1A is a diagram that illustrates an outsourcing environment 100 in accordance with one or more embodiments. In the illustrated embodiment, the outsourcing environment 100 includes an outsourcing management system (“management system”) 102, an outsourcing client organization (or “outsourcing client” or “client”) 104, one or more outsourcing provider organizations (or “outsourcing providers” or “providers”) 106 (e.g., including outsourcing providers 106a and 106b), and an outsourcing target environment (or “target environment”) 108. The management system 102 includes a sourcing engine 120 and a sourcing information database (or “sourcing database”) 122 storing associated sourcing data 124. The sourcing engine 120 includes a scoping module 130, a training module 132, and a monitoring module 134. The sourcing data 124 includes an element definition mapping 140, a process definition mapping 142, a scoping training dataset 144, attribute mappings 146, scoping models 148, scoping parameters 150, monitoring data 152, and scope models 170. The attribute mappings 146 include a maturity mapping 160, a duration mapping 162, and a resource mapping 164. In some embodiments, the management system 102, the outsourcing client 104, or each of some or all of the outsourcing providers 106, include or otherwise employ a computer system that is the same as or similar to computer system 1100 described with regard to at least FIG. 11.

As described, an entity, such as an outsourcing client 104, may provide scoping parameters 150 that generally define desired outsourcing operations relating to a target environment 108. These scoping parameters 150 may, in turn, be employed by the sourcing engine 120 to generate a corresponding scope model 170. The scope model 170 may, for example, be provided in an outsourcing SOW 172 (e.g., including corresponding element definitions 174 and process definitions 176) to specifically define the scope of outsourcing of tasks of the target environment 108, to be performed by one or more outsourcing providers 106 (or to be retained by the outsourcing client 104).

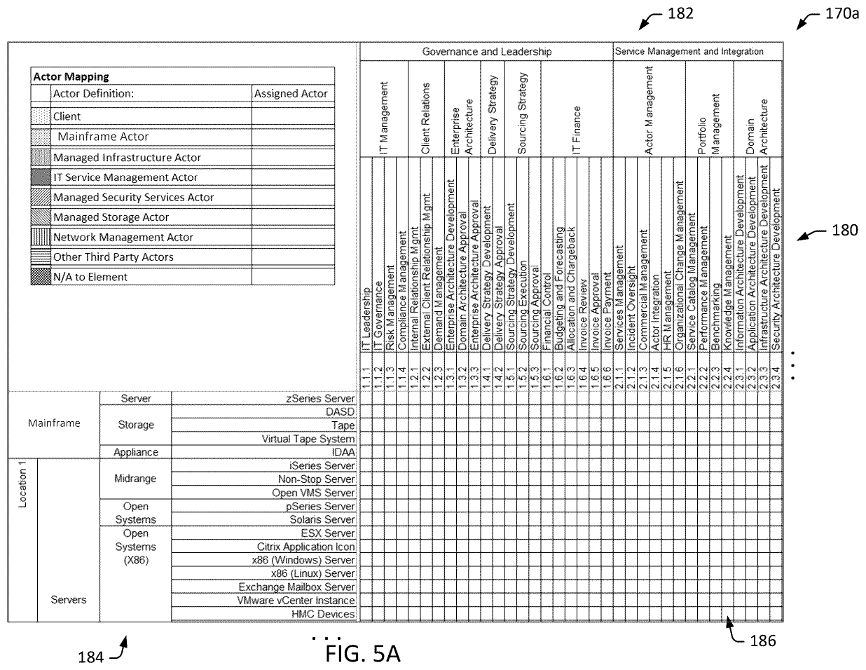

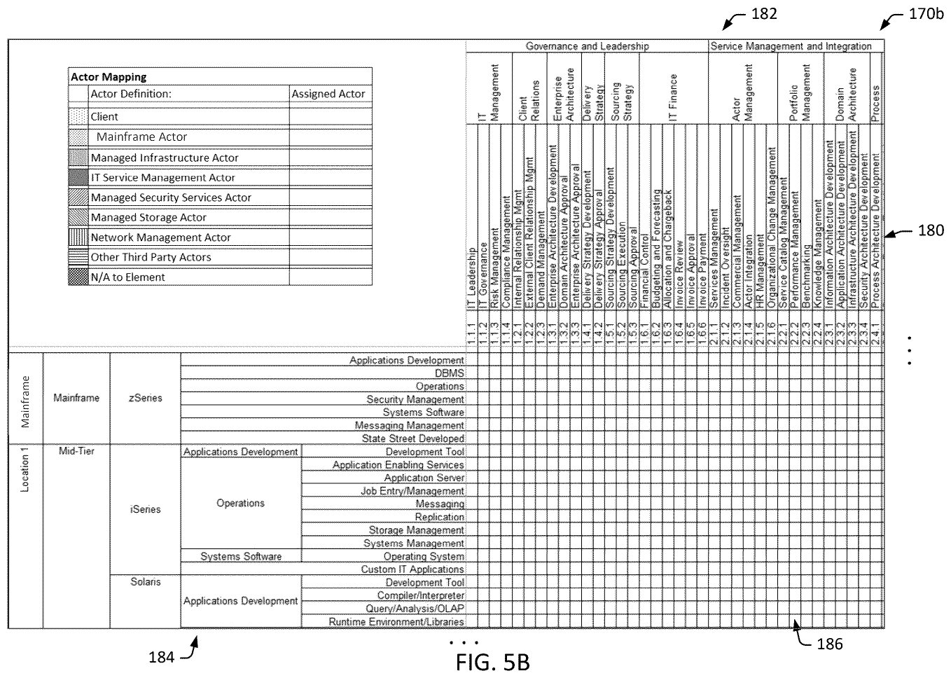

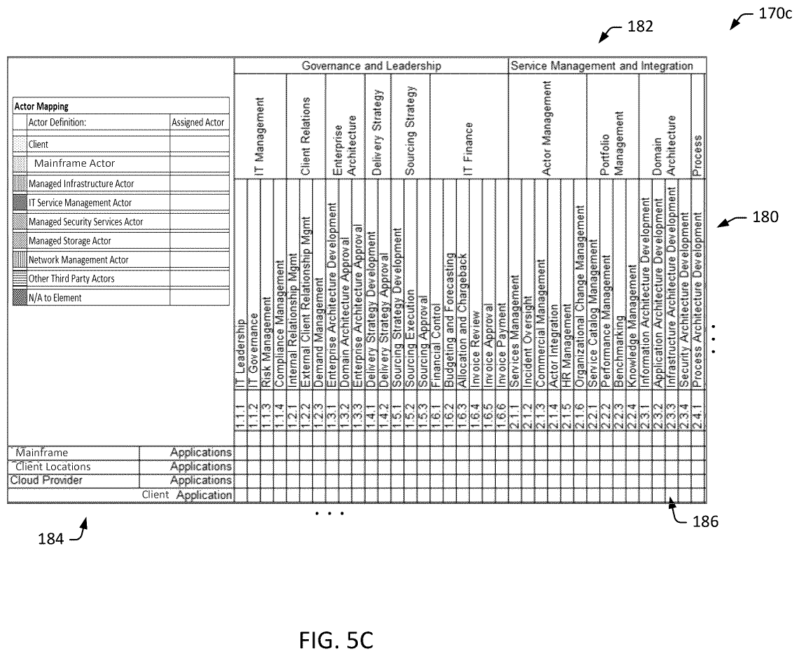

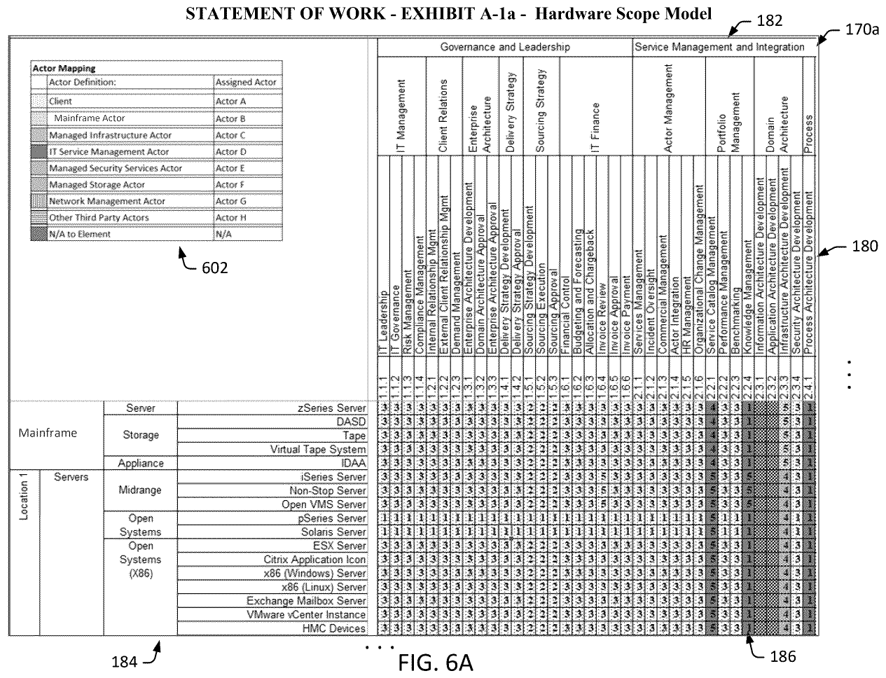

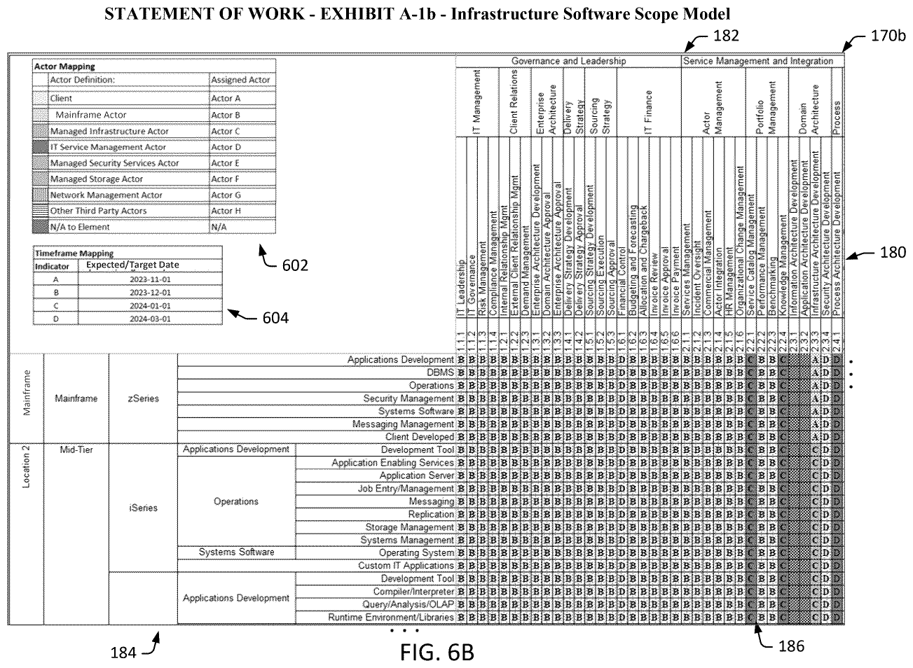

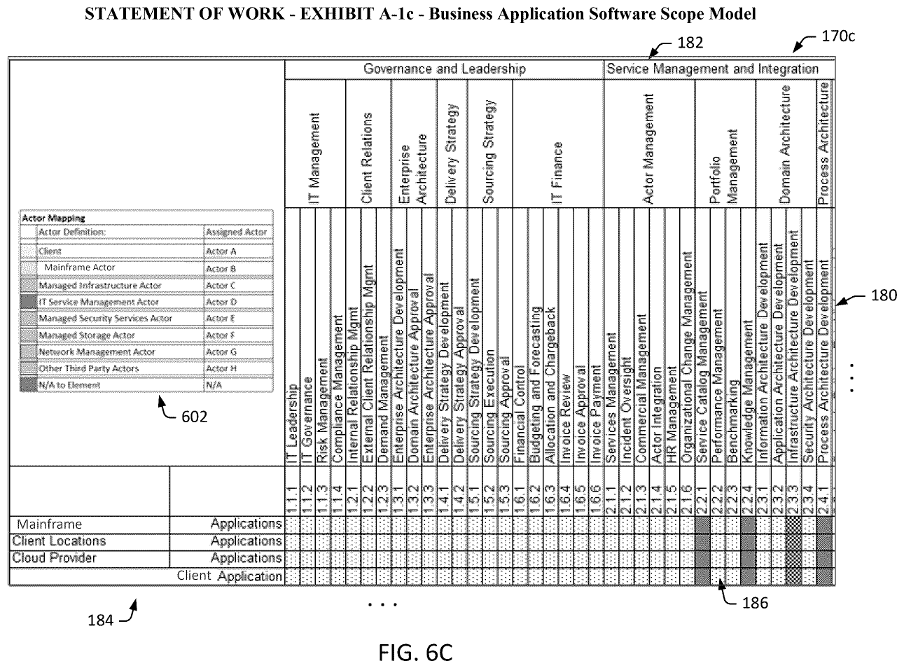

In some embodiments, a scope model 170 defines outsourcing tasks to be performed by one or more outsourcing providers 106 (or to be retained by the outsourcing client 104). In some embodiments, a scope model 170 includes a corresponding process-element matrix (“P-E matrix”) 180 having a set of process components (“processes”) 182 (see, e.g., “P” representing individual process components) and a set of element components (“elements”) 184 (see, e.g., “E” representing individual element components) defining respective sets of process-element (P-E) pairs (or “cells”) 186 (see, e.g., each given process-element pair 186 for a given process “P” and a given element “E” being defined by the cell at the intersection of the column for “P” and the row for “E”). In some embodiments, some or all of the P-E pairs 186 of a scope model 170 are populated with an assigned actor (see, e.g., each “A” representing a respective assigned actor for each of the process (P-E) element pairs 186). For example, where an Actor A is assigned responsibility for a process (P) to be performed on a given element (E), the cell for the corresponding P-E pair 186 may be populated with an indication that Actor A is assigned responsibility therefor. This may include, for example, populating the cell for the corresponding P-E pair 186 with text, symbols, coloring, shading, or the like indicative of Actor A. In some embodiments, some or all of the P-E pairs 186 are populated with characteristics of the respective P-E pair 186. This may include, for example, indications of a maturity, duration, resource level, or the like associated with the process (P), element (E), the process-element pair (P-E), or the actor assigned to the P-E pair 186. For example, where an Actor A is assigned responsibility for a process (P) to be performed on a given element (E) and is associated with a maturity score of “5”, the cell for the P-E pair 186 may be shaded in a color indicative of Actor A being assigned to the P-E pair 186, and may be populated with the number “5” to indicate that the assigned actor has a maturity score of 5. In some embodiments, a maturity score may be determined in accordance with a given technique of maturity scoring or otherwise defining maturity, such as Capability Maturity Model Integration (CMMI). Such a populated scope model 170 may enable persons to quickly and easily decipher what actors are assigned to what tasks, and attributes of individual combinations of processes, elements and actors. Examples of scope models 170 (unpopulated and populated) are described in more detail with regard to at least FIGS. 5A-6C. As described, an outsourcing operation may be performed in accordance with outsourcing parameters defined by a scope model 170, including the process, element and actor assignments defined by the scope model 170. Further, as described, the processes, elements, actors, and associated attributes of a scope model 170 may be generated by way of a scoping process that may employ manual efforts, artificial intelligence (AI) based modeling, or the like.

In some embodiments, an outsourcing client 104 is an entity, such as a company or individual, that engages the services of one or more external third-party outsourcing providers (e.g., outsourcing providers 106) to handle specific tasks. For example, outsourcing client 104 may be a webservices company that is engaging outsourcing providers 106 to handle aspects of its information technology (IT) infrastructure, including aspects of installing and managing certain hardware (e.g., servers, databases, or the like), software (e.g., security management applications, database management applications, or the like) and associated processes (e.g., setup, operation, and maintenance of corresponding hardware and software). In some embodiments, an outsourcing client 104 may include or otherwise employ an outsourcing consultant, such as a third-party tasked with assisting the outsourcing client 104 with defining and executing an outsourcing operation.

In some embodiments, an outsourcing provider 106 is an entity, such as a company or individual, that provides services to handle specific business functions or processes (or “tasks”) for one or more external third-party outsourcing clients (e.g., outsourcing client 104). For example, outsourcing provider 106a may be a company that specializes in hardware installation and management and may be engaged by outsourcing client 104 to manage and operate certain aspects of the hardware (e.g., servers, databases, or the like) of the webservices business of outsourcing client 104. Further, outsourcing provider 106b may be a company that specializes in software installation and management and may be engaged by outsourcing client 104 to install and manage certain aspects of the software (e.g., security management applications, database management applications, or the like) of the webservices business of outsourcing client 104. As another example, an outsourcing provider 106 may be a company that specializes in services that is engaged by outsourcing client 104 to provide certain aspects of services (e.g., helpdesk, deskside support, security monitoring, or the like). In some embodiments, an outsourcing provider 106 may include or otherwise employ an outsourcing consultant, such as a third-party tasked with assisting the outsourcing provider 106 with defining and executing an outsourcing operation.

In some embodiments, a target environment 108 includes a specific set of functions, processes, or tasks that a company decides to delegate to one or more external third-party outsourcing providers (e.g., outsourcing providers 106). Continuing with the above example, the target environment 108 may include the hardware (e.g., servers, databases, or the like), the software (e.g., security management applications, database management applications, or the like), and the services (e.g., helpdesk, deskside support, security monitoring, or the like) of the webservices business of outsourcing client 104 that are subject to tasks to be handled by one or more outsourcing providers 106, or the outsourcing client 104.

In some embodiments, the sourcing engine 120 is operable to complete various tasks described here, such as generation and implementation of a scope model, training of scoping models, monitoring of implementation of scope models, or the like.

In some embodiments, the scoping module 130 is a software application that is operable to generate and implement scope models 170. This may include, for example, generating a scope model 170 (e.g., including a process-element matrix defining process-element pairs) based on scoping parameters 150 (e.g., based on the application of scoping parameters 150 to a scoping model 148), and generating a corresponding SOW 172 that includes the scope model 170 and associated element definitions 174 and process definitions 176. The SOW may, for example, be used to define tasks to be performed by outsourcing providers 106 (and the outsourcing client 104) in the target environment 108.

In some embodiments, the training module 132 is a software application that is operable to train and retrain scoping models 148 for use in generating scope models 170 based on scoping parameters 150. This may include training and retraining scoping models 148 based on the scoping training dataset 144 (e.g., which may include historical sets of scoping parameters 150 and scoping models 170 generated therefrom), to generate one or more scoping models 148 that can be used to generate a scope model 170 based on a set of scoping parameters 150.

In some embodiments, the monitoring module 134 is a software application that is operable to monitor performance of tasks in a target environment 108 or associated performances of entities, such as outsourcing providers 106 or outsourcing clients 104. This may include obtaining monitoring data 152, such as feedback concerning performance and capabilities of outsourcing providers 106 or outsourcing clients 104, and making corresponding updates to the attribute mapping 146. Such monitoring and updating may provide a feedback loop that enables regular updates to underlying data used to generate scope models 170, thereby providing an efficient and effective mechanism to improve scope models 170 and associated SOWs 172.

In some embodiments, scoping parameters 150 define one or more aspects of an outsourcing project. For example, a set of scoping parameters 150 for a given outsourcing project may include definitions of one or more components of a target environment 108 (e.g., including task to be performed in the target environment 108), one or more tasks to of the target environment 108 to be outsourced, capabilities of the outsourcing client 104, one or more outsourcing providers 106 and their associated capabilities, or the like. For example, in the context of an IT outsourcing project, a set of scoping parameters 150 for the project may include definitions of the hardware and software infrastructure of the business of outsourcing client 104 and associated task therefor, a listing of the types of tasks or specific tasks that the outsourcing client 104 is interested in outsourcing, and a listing of one or more candidate outsourcing providers 106 and their respective capabilities. In some embodiments, a scope model 170 is generated based on scoping parameters. For example, as described, a scoping model 148 may be trained to generate a scope model 170 based on a set of scoping parameters 150, and a scope model 170 may be generated based on application of a given set of scoping parameters 150 (e.g., provided by outsourcing client 104) to the scoping model 148. As another example, a person, such as the outsourcing client 104, an outsourcing provider 106, or other entity, may generate or populate a scope model 170 based on scoping parameters 150.

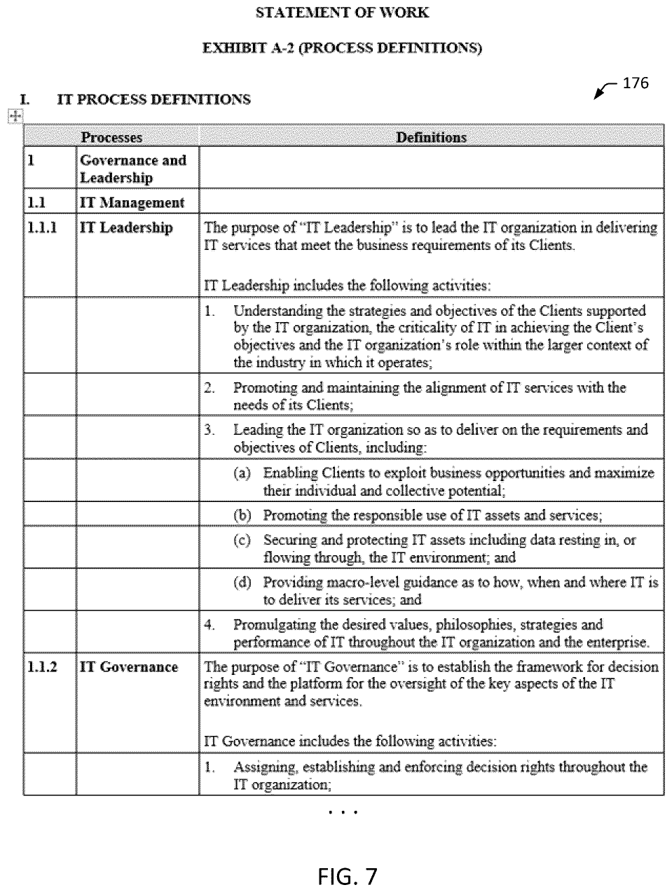

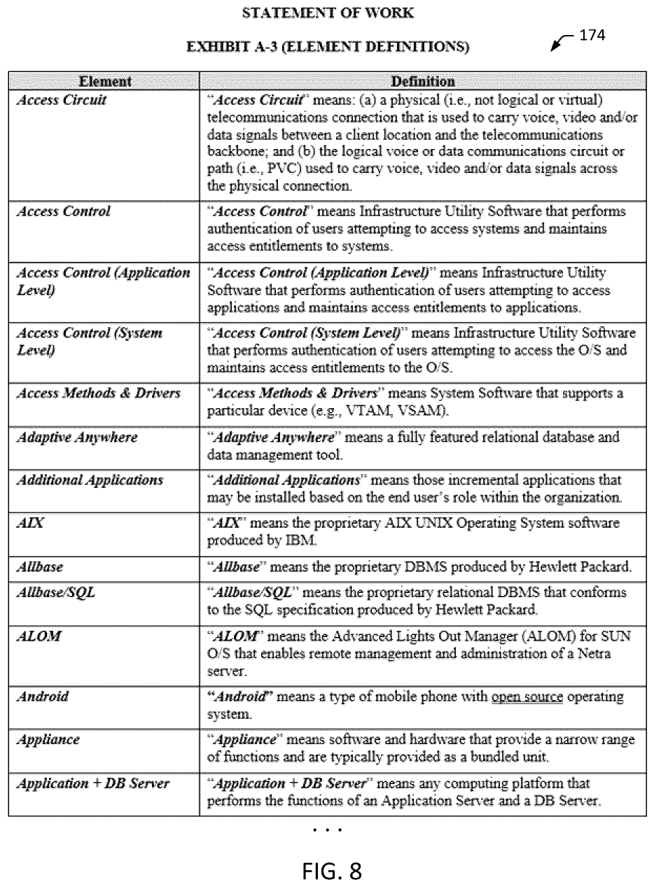

In some embodiments, an outsourcing SOW 172 is a formal document (or set of documents) that outlines details and expectations of an outsourcing project or service to be provided by one or more third-party vendors or service providers. A SOW may serve as a contractual agreement between the outsourcing client 104 and one or more outsourcing providers 106. In some embodiments, a scope model 170 is provided as a component of a SOW. For example, a SOW 172 for outsourcing of tasks of the target environment 108, by the outsourcing client 104 to one or more outsourcing providers 106, may include a scope model 170, as well as corresponding element definitions 174 and process definitions 176, that specifically define the scope of outsourcing of tasks of the target environment 108, to be performed by one or more outsourcing providers 106 (or to be retained by the outsourcing client 104). FIGS. 6A, 6B, 6C, 7 and 8 illustrate portions of an example SOW 172 in accordance with one or more embodiments. As described below, FIGS. 6A-6C illustrate an example scope model 170 that includes a populated hardware scope model 170a (see FIG. 6A), a populated infrastructure software scope model 170b (see FIG. 6B), and a populated business application software scope model 170c (see FIG. 6C). FIG. 7 illustrates a set of definitions, including a set of process definitions 176 corresponding to the processes of the scope model 170 (including scope models 170a-170c). FIG. 8 illustrates a set of element definitions 174 corresponding to the elements of the scope model 170 (including scope models 170a-170c). As described, each of the scope models 170 (including each of scope models 170a, 170b and 170c), as well as the set of process definitions 176 and the set of element definitions 174 may be included in the SOW 172, along with other relevant documents and information concerning the associated outsourcing operation.

In some embodiments, an element definition 174 defines one or more aspects of an associated element, such as what items (e.g., computers, software, hardware, or the like) constitute the element. In some embodiments, a scope model 170 includes or is otherwise accompanied by a set of element definitions 174 that correspond to elements of the scope model 170. For example, where a scope model 170 includes a process-element matrix 180 that includes Elements A-G for which various processes are to be performed by various actors, a set of element definitions 174 for the scope model 170 may include a respective definition for each of Elements A-G.

In some embodiments, element definitions for a scope model 170 are generated based on an element definition mapping 140. For example, an element definition mapping 140 may include an element definition 174 for each element of a set of Elements A-Z, and the scoping module 130 may, for each of Element A-G included in the matrix of a scope model 170, extract a corresponding element definition 174 from the element definition mapping 140 and assemble the extracted element definitions 174 into a set of element definitions 174 for the scope model 170, including a respective definition 174 for each of Element A-G. Such a technique may enable automated generation of element definitions 174 for a scope model 170 based on a predetermined mapping of element definitions. As described, such a set of element definitions 174 may be included with, or otherwise accompany, a scope model 170, for example, in a SOW 172.

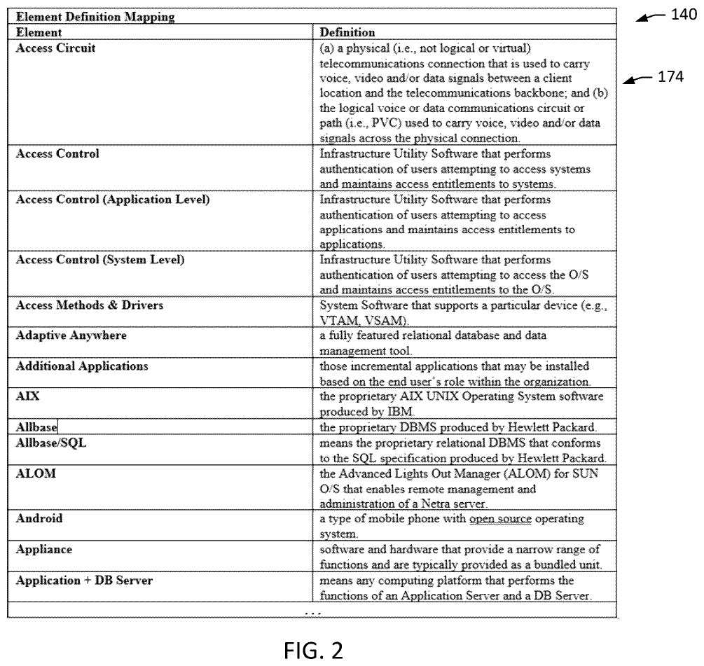

In some embodiments, an element definition mapping 140 includes a mapping of each of one or more elements to a corresponding definition of the element. FIG. 2 is a diagram that illustrates an example element definition mapping 140 in accordance with one or more embodiments. In the illustrated embodiment, the element definition mapping 140 includes a respective element definition 174 for each of several different elements (e.g., access circuit, access control, and so forth). The element definition 174 for an element may define the extent and bounds of the element. For example, an element definition 174 for an element of “Access Circuit” may include a definition of the following: “means: (a) a physical (i.e., not logical or virtual) telecommunications connection that is used to carry voice, video and/or data signals between a client location and the telecommunications backbone; and (b) the logical voice or data communications circuit or path (i.e., PVC) used to carry voice, video and/or data signals across the physical connection.” An element definition 174 may enable parties (e.g., the party(s) assigned or not assigned to the process) to fully understand what components of a system are (and are not) subject to a process associated with the element.

In some embodiments, a process definition 176 defines one or more aspects of an associated process, such as what actions (e.g., one or more tasks to be performed by an entity) are involved in performance of the process. In some embodiments, a scope model 170 includes or is otherwise accompanied by a set of process definitions 176 that correspond to processes of the scope model 170. For example, where a scope model 170 includes a process-element matrix 180 that includes Processes A-G to be performed on various elements by various actors, a set of process definitions 176 for the scope model 170 may include a respective definition for each of Processes A-G.

In some embodiments, process definitions 176 for a scope model 170 are generated based on a process definition mapping 142. For example, a process definition mapping 142 may include a definition for each process of a set of Processes A-Z, and the scoping module 130 may, for each of Processes A-G included in the process-element matrix 180 of a scope model 170, extract a corresponding process definition 176 from the process definition mapping 142 and assemble the extracted process definitions 176 into a set of process definitions 176 for the scope model 170, including a respective definition for each of Process A-G. Such a technique may enable automated generation of process definitions 176 for a scope model 170 based on a predetermined mapping of process definitions. As described, such a set of process definitions 176 may be included with, or otherwise accompany, a scope model 170, for example, in a SOW 172.

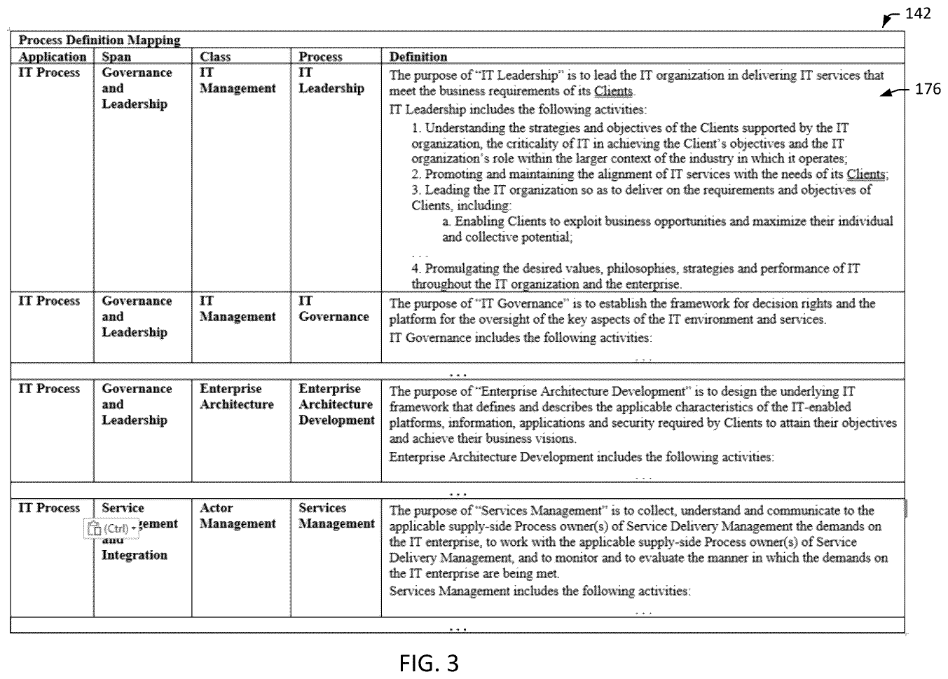

In some embodiments, a process definition mapping 142 includes a mapping of each of one or more processes to a corresponding definition of the process. FIG. 3 is a diagram that illustrates an example process definition mapping 142 in accordance with one or more embodiments. In the illustrated embodiment, the process definition mapping 142 includes a respective process definition 176 for each of several different processes (e.g., IT Leadership, IT Governance, and so forth). The process definition 176 for a process may define the extent and bounds of activities associated with the process, which are to be performed or otherwise managed by an associated actor. For example, a process definition 176 for a process of “IT Leadership” may include a definition of “The purpose of ‘IT Leadership”’ is to lead the IT organization in delivering IT services that meet the business requirements of its Clients. IT Leadership includes the following activities: (1) Understanding the strategies and objectives of the Clients supported by the IT organization, the criticality of IT in achieving the Client's objectives, and the IT organization's role within the larger context of the industry in which it operates; (2) Promoting and maintaining the alignment of IT services with the needs of its Clients; (3) Leading the IT organization so as to deliver on the requirements and objectives of Clients, including: (a) Enabling Clients to exploit business opportunities and maximize their individual and collective potential; (b) Promoting the responsible use of IT assets and services; (c) Securing and protecting IT assets including data resting in, or flowing through, the IT environment; and (d) Providing macro-level guidance as to how, when, and where IT is to deliver its services; and (e) Promulgating the desired values, philosophies, strategies, and performance of IT throughout the IT organization and the enterprise.” A process definition 176 for a process may enable parties (e.g., the party(s) assigned or not assigned to the process) to fully understand what tasks are delegated (and are not delegated) to an actor assigned to the process.

In some embodiments, an attribute mapping 146 defines attributes of one or more components of a scope model. For example, attribute mapping 146 may define one or more attributes of one or more processes, one or more elements, one or more actors (A), or the like, of a scope model 170. In some embodiments, a scope model 170 is populated with one or more values corresponding to the attributes of attribute mapping 146. For example, where attribute mapping 146 defines an attribute of a component (e.g., an attribute of a process, an element, or an actor), a scope model 170 generated based on the attribute mapping 146 may include an indication of the attribute in a portion of the scope model 170 corresponding to the component. In some embodiments, a cell of a P-E pair 186 of a process-element matrix 180 of a scope model 170 corresponding to a component (defined by or otherwise associated with an attribute) is populated with a value indicative of the attribute. For example, where attribute mapping 146 indicates that Actor A is associated with Attribute X, each of the cells for a P-E pair 186 of the process-element matrix 180 of a corresponding scope model 170 that are assigned to the Actor A (e.g., each process-element pair of the matrix of the scope model 170 assigned to Actor A) may be populated or otherwise associated with Attribute X. Such an indication may provide an efficient and effective mechanism for defining and communicating attributes of process-element pairs 186 of a scope model 170. This may, in turn, provide for efficient and effective assessment, modification, and implementation of a scope model 170 and associated outsourcing operations.

In some embodiments, an attribute mapping 146 includes a maturity-type attribute mapping (“maturity mapping”) 160. In some embodiments, a maturity mapping 160 provides an indication of a level of maturity of one or more actors with regard to one or more components of a scope model. For example, a maturity mapping 160 may define for each of one or more of a given process, element, or process-element pair of a scope model 170, a maturity score for one or more actors. In some embodiments, maturity of an actor for a component is indicative of that actor's experience with the given component or ability to successfully perform an associated process on/for the component. For example, a maturity mapping 160 may define for Actor A, a maturity score (e.g., a score of 1-5) for each process of a set of processes of a scope model 170, a maturity score for each element of a set of elements of the scope model 170, and a maturity score for each process-element pair of the set of processes and the set of elements of the scope model 170. As described, these maturity scores may be used to populate corresponding cells of a matrix, to effectively communicate maturity for components, combinations of components, or the like.

In some embodiments, cells of the matrix of a scope model 170 are populated with a corresponding level of maturity. For example, each of the cells of P-E pairs 186 of a process-element matrix 180 of a scope model 170 that are assigned to the Actor A (e.g., each process-element pair of the matrix of the scope model assigned to Actor A) may be populated or otherwise associated with a maturity score for Actor A, a maturity score for Actor A and the corresponding process, a maturity score for Actor A and the corresponding element, or a maturity score for Actor A and the corresponding process-element combination (or “process-element pair”). Such an indication may provide an efficient and effective mechanism for defining and communicating maturity levels of assigned actors for processes, elements, or process-element pairs of a scope model. This may, in turn, provide for efficient and effective assessment, modification, and implementation of a scope model 170 and associated outsourcing operations.

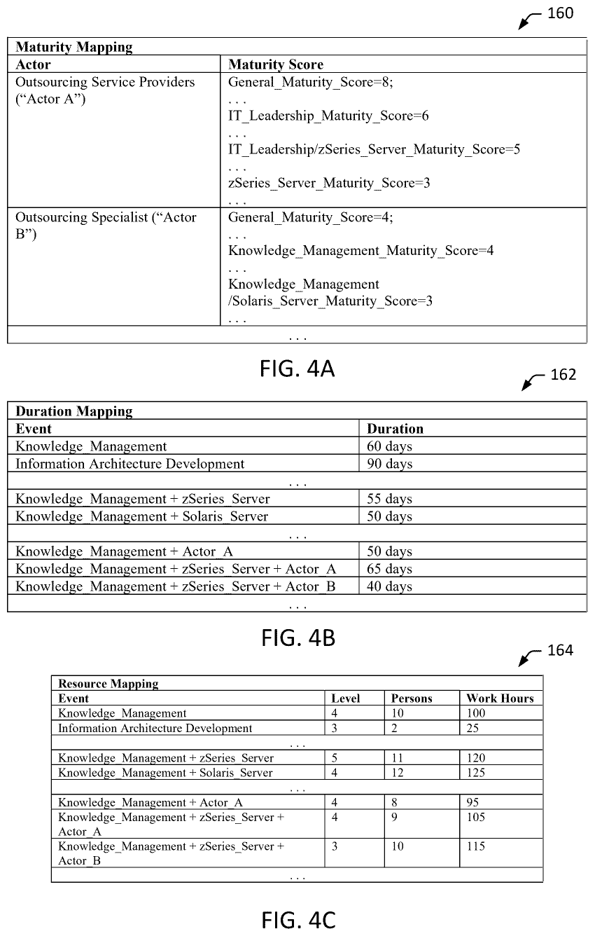

FIG. 4A is a diagram that illustrates an example maturity mapping 160 in accordance with one or more embodiments. In some embodiments, a maturity score is based on an actor's overall ability. For example, where Actor A is determined to have a maturity score of 8 (e.g., based on the number of times Actor A has been a party to a similar form of outsourcing), a maturity mapping 160 may include a mapping of the maturity score of 8 to Actor A (e.g., Actor_A: General_Maturity_Score=8). In some embodiments, a maturity score is based on actor's ability with regard to a specific component, such as a given process or element. For example, where Actor A is assigned a maturity score of 6 for Process Y (e.g., based on the number of times Actor A has performed Process “IT Leadership”), a maturity mapping 160 may include a mapping of the maturity score of 4 to Actor A for the process (e.g., Actor_A: IT_Leadership_Maturity_Score=6). Similarly, where Actor A is assigned a maturity score of 3 for Element Y based on the number of times Actor A has performed a process on Element Y, a maturity mapping 160 may include a mapping of the maturity score of 3 for Actor Y for Element Y (e.g., Actor_A: zSeries_Server_Maturity_Score=3). In some embodiments, a maturity score is based on an actor's ability with regard to a combination of components, such as a given process and element combination. For example, where Actor A is assigned a maturity score of 2 for Process Y for Element Y (e.g., based on the number of times Actor A has performed IT_Leadership for a zSeries Server), a maturity mapping 160 may include a mapping of the maturity score of 5 to Actor A for the process (e.g., Actor A: IT_Leadership/zSeries Server_Maturity_Score=5).

In some embodiments, an attribute mapping 146 includes a temporal-type attribute mapping (“temporal mapping”) 162. In some embodiments, a temporal mapping 162 provides an indication of a time associated with performing one or more processes of a scope model. For example, a temporal mapping 162 may define for each of one or more of a given process, process-element pair, process-actor pair, or process-element-actor combination, a duration indicative of an amount of time to perform the process. In some embodiments, a time for a process (and any associated components) is indicative of a target or expected amount of time to perform the associated process. For example, a temporal mapping 162 may define for each process of a set of process, a set of processes-element combinations (e.g., for each respective pair of a process performed for an element), a set of processes-element-actor combinations (e.g., for each respective pair of a process performed for an element, by an actor), or a set of processes-actor combinations (e.g., for each respective pair of a process performed by an actor), an associated duration or time that is indicative of a target or expected amount of time to complete the associated process (e.g., to complete the process in general, for the associated element, by the associated actor, or for the associated element by the associated actor). In some embodiments, a time for a process (and any associated components) is indicative of a target or expected time to complete or begin performance of the associated process. This may be referred to as an “effective date” (e.g., a date/time when a responsibility comes into effect). For example, a temporal mapping 162 may define for each process of a set of process, set of processes-element combinations (e.g., for each respective pair of a process performed for an element), set of processes-element-actor combinations (e.g., for each respective pair of a process performed for an element, by an actor), or set of processes-actor combinations (e.g., for each respective pair of a process performed by an actor), an associated duration or time that is indicative of a target or expected time to complete or begin performance of the associated process (e.g., a date/time to complete or start the process in general, for the associated element, by the associated actor, or for the associated element by the associated actor). As described, these durations may be used to populate corresponding cells of a matrix, to effectively communicate process durations for components, combinations of components, or the like.

In some embodiments, cells of the matrix of a scope model 170 are populated with a corresponding time. For example, each of some or all of the cells of P-E pairs 186 of a process-element matrix 180 of a scope model 170 may be populated or otherwise associated with a corresponding time for with the associated process (e.g., an expected date/time to start or complete the process in general, for the associated element, by the associated actor, or for the associated element by the associated actor). Such an indication may provide an efficient and effective mechanism for defining and communicating target or expected times of completion of respective processes of a scope model 170. This may, in turn, provide for efficient and effective assessment, modification, and implementation of a scope model 170 and associated outsourcing operations.

FIG. 4B is a diagram that illustrates an example temporal mapping 162 in accordance with one or more embodiments. In some embodiments, a temporal mapping 162 includes mappings of time to individual items, such as a given actor, process, or element. For example, where Process Y takes 60 days to complete on average, a temporal mapping 162 may include a mapping of a duration of time of 60 days to Process Y (e.g., Knowledge_Management: Duration=60 days). In some instances, an attribute may be associated with a combination of one or more items, such as a combination of one or more actors, processes, or elements. For example, where Actor A has historically completed Process Y in 50 days, a temporal mapping 162 may include a mapping of the duration of 50 days to the combination of Actor A executing Process Y (e.g., Actor_A+Knowledge_Management: Duration=50 days). As another example, where Actor A has historically completed Process Y on Element Y in 65 days, a temporal mapping 162 may include a mapping of the duration of 65 days to the combination of Actor A executing Process Y on Element Y (e.g., Knowledge_Management+zSeries Server+Actor_A: Duration=65 days). As described, such times or durations of time may be used to determine how long a process may take, when a process may start, or when a process is to be completed. Such indications may be particularly useful for scheduling of associated tasks and related tasks.

In some embodiments, an attribute mapping 146 includes a resource-type attribute mapping (“resource mapping”) 164. In some embodiments, a resource mapping 164 provides an indication of an amount of resources (e.g., hardware, effort, or the like) associated with performing one or more processes of a scope model. For example, a resource mapping 164 may define, for each of one or more of a given process, process-element pair, process-actor pair, or process-element-actor combination, of a scope model 170, a resource level that is indicative of an amount of resources (e.g., hardware, effort, or the like) associated with the process. In some embodiments, a resource level for a process (and any associated components) is indicative of a target or expected amount of one or more resources (e.g., number of computers, number of software applications, processors, number of persons, hours worked, fuel consumed, waste created, or the like) for performing the associated process. For example, a resource mapping may define for each process of a set of processes, a set of processes-element combinations (e.g., for each respective pair of a process performed for an element), a set of processes-element-actor combinations (e.g., for each respective pair of a process performed for an element, by an actor), or a set of processes-actor combinations (e.g., for each respective pair of a process performed by an actor), an associated resource level that is indicative of a target or expected amount of one or more resources of resources for performing the associated process (e.g., to complete the process in general, for the associated element, by the associated actor, or for the associated element by the associated actor). As described, these resource levels may be used to populate corresponding cells of a matrix, to effectively communicate resources for components, combinations of components, or the like.

In some embodiments, cells of the matrix of a scope model 170 are populated with a corresponding resource level. For example, each of the cells of P-E pairs 186 of a process-element matrix 180 of a scope model 170 may be populated or otherwise associated with a corresponding resource level associated with the associated process (e.g., an expected level of resource to complete the process in general, for the associated element, by the associated actor, or for the associated element by the associated actor). Such an indication may provide an efficient and effective mechanism for defining and communicating target or expected resources for completion of respective processes of a scope model 170. This may, in turn, provide for efficient and effective assessment, modification, and implementation of a scope model 170 and associated outsourcing operations.

FIG. 4C is a diagram that illustrates an example resource mapping 164 in accordance with one or more embodiments. In some embodiments, a resource mapping 164 includes mappings of resource levels to individual items, such as a given actor, process, or element. For example, where Process Y requires 100 works hours to complete, a resource mapping 164 may include a mapping of a resource level of 100 hours to Process Y (e.g., Knowledge_Management: Work_Hours=100 hours). In some instances, an attribute may be associated with a combination of one or more items, such as a combination of one or more actors, processes, or elements. For example, where Actor A has historically completed Process Y in 95 work hours, a resource mapping 164 may include a mapping of the resource level of 95 work hours to the combination of Actor A executing Process Y (e.g., Knowledge_Management+Actor_A: Work_Hours=95 hours). As another example, where Actor A has historically completed Process Y on Element Y in 105 work hours, a resource mapping 164 may include a mapping of the resource level of 105 work hours to the combination of Actor A executing Process Y on Element Y (e.g., Knowledge_Management+zSeries Server+Actor_A: Work_Hours=105 hours).

In some embodiments, attribute mappings 146 are generated or updated based on relevant monitoring data, such as feedback information. For example, feedback-type monitoring data 152 may be provided in response to implementation of a scope model 170, and the attribute mappings 146 (e.g., maturity mapping 160, temporal mapping 162, or resource mapping 164) may be updated to reflect the feedback.

In some embodiments, monitoring data 152 includes information provided that is indicative of performance of associated aspects of implementation of a scope model. For example, monitoring data 152 may include feedback information, such as comments provided by outsourcing client 104, one or more outsourcing providers 106, or another entity. The feedback information may include, for example, maturity feedback (e.g., a scoring value indicative of the actual performance of actors), temporal feedback (e.g., a time value indicative of the actual amount of time required to complete various processes), resource feedback (e.g., a resource level value indicative of the actual amount of resources required to complete various processes), or the like. In some embodiments, attribute mappings 146 are updated to reflect monitoring data 152. For example, a maturity mapping 160 may be updated based on maturity feedback (e.g., increasing or decreasing maturity scores for actors based on feedback for the actors), a temporal mapping 162 may be updated based on temporal feedback (e.g., increasing or decreasing durations for processes based on feedback for observed process durations), and a resource mapping 164 may be updated based on resource feedback based on (e.g., increasing or decreasing resource levels for processes based on feedback for observed process resource requirements). Such generating or updating based on monitoring data 152 may provide an efficient and effective mechanism for defining, updating, and communicating attributes of outsourcing and components of a scope model 170. This may, in turn, provide for efficient and effective assessment, modification, and implementation of a scope model 170 and associated outsourcing operations.

In some embodiments, determination of a scope model 170 employs artificial intelligence (AI) based modeling. For example, a scoping model 148 may be an AI-based model that is trained based on a scoping training dataset 144 to generate a scope model 170 based on a given set of scoping parameters 150. In such an embodiment, an outsourcing client 104, or other entity, may provide a set of scoping parameters 150 that define requirements of an IT outsourcing project, such as definitions of the hardware and software infrastructure of the business outsourcing client 104, a listing of the types of tasks, or specific tasks, that the outsourcing client is interested in outsourcing, and a listing of one or more candidate outsourcing providers 106 and their respective capabilities. The scoping module 130 may select, from a set of various scoping models 148, an “IT” scoping model 148 trained to generate a scope model 170 based on a given set of scoping parameters 150, and feed the set of scoping parameters 150 into the scoping model 148, such that the scoping model 148 generates a corresponding scope model 170 for the IT outsourcing project. As described, the scope model 170 may include, for example, a process-element matrix (e.g., including unpopulated, partially populated, or fully populated process-element pairs) that provides a basis for the IT outsourcing project. The outsourcing client 104 and associated outsourcing providers 106 may review and revise the scope model 170 into an acceptable form, if needed, and ultimately incorporate the scope model 170 into a SOW 172 between the parties. As described, in some embodiments, the scoping module 130 may generate a SOW 172 that incorporates the scope model 170 and associated information, such as element and process definitions.

In some embodiments, a scoping model 148 is a machine learning model that is operable to determine a scope model 170 based on a set of scoping parameters 150. For example, a scoping model 148 may be a machine learning model employing one or more trained machine learning algorithms that are operable to determine a scope model 170 (e.g., including a process-element matrix having unpopulated, partially populated, or fully populated process-element pairs) a for use in defining an outsourcing relationship between an outsourcing client 104 and one or more outsourcing providers 106. In some embodiments, a scoping model 148 is trained using historical structured or unstructured data. For example, a scoping model 148 may be trained using a scoping training dataset 144 that includes respective sets of scoping parameters 150 for outsourcing projects and corresponding scope models 170, to generate a scoping model 148 that is operable to map a respective set of scoping parameters 150 to a scope model 170. In some embodiments, the scoping model 148 employs a machine learning algorithm, such as Linear Regression, Decision Trees, Random Forest, Support Vector Machines (SVM), Neural Networks, Gradient Boosting, K-Nearest Neighbors (KNN), or the like. For example, the scoping model 148 may employ a SVM model trained using historical scoping parameters 150 and scope models 170 generated therefor, to determine a scope model 170 (e.g., including a process-element matrix having unpopulated, partially populated, or fully populated process-element pairs) for an outsourcing project based on a set of scoping parameters 150 for the outsourcing project.

A given algorithm may be implemented based on its operation and characteristics. For example, Linear regression modeling may be useful where there is a linear relationship between input (e.g., parameters) and output (e.g., scope model components). Decision tree modeling may recursively split data based on attribute values, which may make it effective for capturing complex decision-making processes with both categorical and numerical attributes. Random Forest modeling may construct multiple decision trees and combine their outputs, which may make it useful for reducing overfitting and improving accuracy by aggregating predictions. SVM modeling may find a hyperplane that maximally separates classes in a high-dimensional space, which may make it beneficial when a clear margin of separation exists. Neural network modeling may create layers of interconnected nodes to learn hierarchical representations, which may be suitable for capturing complex, non-linear relationships in large datasets. Gradient boosting may build trees sequentially, with each tree correcting the errors of the previous ones, and may be effective for combining weak learners to create a strong predictive model. KNN modeling may classify a data point based on the majority class of its k nearest neighbors, which may benefit tasks emphasizing local similarity.

In some embodiments, a scoping training dataset 144 includes historical scoping data obtained over time. For example, a scoping training dataset 144 may include sets of scoping parameters 150 for various outsourcing projects and respective scope models 170 generated therefor, for a preceding duration of time (e.g., submitted and generated over the last five years). As described, as scope models 170 are generated for various outsourcing projects, the scoping training dataset 144 may be updated to include sets of scoping parameters 150 and respective scope models 170 for the various outsourcing projects. Such updating may provide a feedback loop that helps to enhance modeling and model performance.

In some embodiments, training of the scoping model 148 includes pre-processing of the scoping training data set 144. This may include, for example, removing null fields of the scoping training data set 144, cleaning the text of the scoping training data set 144, or the like. In some embodiments, training of the scoping model 148 includes splitting the scoping training dataset 144 into a training data subset, a validation data subset, and a testing data subset. In such an embodiment, the training dataset may be used to train the machine learning model. The validation dataset may be used to finetune the model and optimize its hyperparameters. The testing dataset may be used to assess the model's final performance and generalization to new, unseen data. Such evaluations and fine-tuning may provide relatively accurate models and associated predictions.

FIGS. 5A-6C are diagrams that illustrate example unpopulated and populated scope models 170 in accordance with one or more embodiments. In the illustrated embodiments, each of the scope models 170a-170c includes a corresponding process-element matrix 180 (e.g., process-element matrices 180a, 180b and 180c), having a set of process components 182 (e.g., process components 182a, 182b, and 182c) and a set of element components 184 (e.g., element components 184a, 184b, and 184c) defining respective sets of process-element pairs 186 (e.g., cells at the intersection of corresponding processes and elements). In the illustrated embodiments of FIGS. 5A-5C, the cells for P-E pairs 186 are not populated (e.g., the P-E cells are empty of contents). Such unpopulated scope models 170 may be referred to as “unpopulated” or “template” type scope models 170. In the illustrated embodiments of FIGS. 6A-6C, the cells for P-E pairs 186 are populated (e.g., the P-E cells are complete with contents identifying actors or attributes). Such populated scope models 170 may be referred to as “populated” type scope models 170.

FIG. 5A illustrates an unpopulated hardware scope model 170a in accordance with one or more embodiments. FIG. 5B illustrates an unpopulated infrastructure software scope model 170b in accordance with one or more embodiments. FIG. 5C illustrates an unpopulated business application software scope model 170c in accordance with one or more embodiments. As described, in some embodiments, “unpopulated” or “template” type scope models 170 may be generated and provided as framework for defining the processes, elements, actors and associated attributes of the organizational outsourcing. For example, template scope models, such as those of FIGS. 5A-5C may be generated by the scoping module 130 and provided to one or more entities, such as the outsourcing client 104 or the outsourcing provider(s) 106, that can provide for populating the scope models 170. This may include, for example, and entity deciding what actors are responsible for some or all of the P-E pairs 186 of the scope models 170, populating the corresponding cells of the process-element matrices 180 to indicate the responsible actor and any other relevant attributes, such as maturity, time, resource level, or the like for the combination of process, element, or actor.

FIG. 6A illustrates a populated hardware scope model 170a in accordance with one or more embodiments. FIG. 6B illustrates a populated infrastructure software scope model 170b in accordance with one or more embodiments. FIG. 6C illustrates a populated business application software scope model 170c in accordance with one or more embodiments. As described, in some embodiments, “populated” type scope models 170 may be generated and provided as a framework for defining the processes, elements, actors and associated attributes of the organizational outsourcing. For example, populated scope models 170, such as those of FIGS. 6A-6C may be generated by the scoping module 130 and provided to one or more entities, such as the outsourcing client 104 or the outsourcing provider(s) 106, which may modify the populated scope models 170. As described, in some embodiments, one or more populated scope models 170 may be provided in a SOW 172. In the embodiments of FIG. 6A-6C, each of the scope models 170 includes an actor mapping 602 that maps a given pattern of shading to a given role and actor. For example, the relatively dark shading is mapped to the role of “IT Service Management Actor” and “Actor D”.

In the illustrated embodiments of FIGS. 6A-6C, the cells for the corresponding P-E pairs 186 are filled with a pattern corresponding to a role and actor assigned to handle the corresponding process for the corresponding element. For example, the cells for the corresponding P-E pairs 186 under “Service Catalog Management” and “Knowledge Management” are filled with the relatively dark shading mapped to the role of “IT Service Management Actor” and “Actor D”, indicating that Actor D (and the role of IT Service Management Actor) is assigned to handle the “Service Catalog Management” processes and the “Knowledge Management” for the elements 184 of the scope model 170. Similar shading variations are provided across the P-E pairs 186 of the matrix to indicate assignments of processes for elements to actors.

In the illustrated embodiments of FIGS. 6A and 6B, the cells for the corresponding P-E pairs 186 are populated with a numbers or test indicating attributes of the given P-E pair. For example, the cells for the corresponding P-E pairs 186 are populated with a number (e.g., 1-5) which may be indicative of an attribute, such as maturity, time, resource level, or the like associated with one or more of the process, element, or actor of the P-E pair 186. For example, where the attribute values indicate maturity of the associated actor, the number “4” populated in the cell of the P-E pair 186 for the “Service Catalog Management” process and the “zSeries Sever” element may indicate that the actor has a maturity of “4” for Actor D performing the “Service Catalog Management” process for the “zSeries Sever” element. As another example, where the attribute values indicate resource level for the process-element-actor combination, the number “4” populated in the cell of the P-E pair 186 for the “Service Catalog Management” process and the “zSeries Sever” element may indicate a resource level of “4” for Actor D performing the “Service Catalog Management” process for the “zSeries Sever” element. As yet another example, where the attribute values indicate a duration for the process-element-actor combination, the number “4” populated in the cell of the P-E pair 186 for the “Service Catalog Management” process and the “zSeries Sever” element may indicate a duration of “4” (e.g., 4 days) for Actor D performing the “Service Catalog Management” process for the “zSeries Sever” element.

In some embodiments, the value for a populated attribute is derived from a corresponding attribute mapping 146. For example, where a maturity mapping 160 indicates a maturity of “4” for Actor D performing the “Service Catalog Management” process for the “zSeries Sever” element (e.g., “Service_Catalog_Management/zSeries_Sever_Score=4” for Actor D), the scoping module 130 may determine, based on the maturity mapping 160, a maturity of “4” for Actor D performing the “Service Catalog Management” process for the “zSeries Sever” element, and, in turn, populate the corresponding cell of the P-E pair 186 with the attribute value of “4”. As another example, where a temporal mapping 162 indicates a duration of “4 days” for Actor D performing the “Service Catalog Management” process for the “zSeries Sever” element (e.g., “Service_Catalog_Management+zSeries_Sever_Duration=4 days” for Actor D), the scoping module 130 may determine, based on the temporal mapping 162, a duration of 4 days for Actor D performing the “Service Catalog Management” process for the “zSeries Sever” element, and, in turn, populate the corresponding cell of the P-E pair 186 with the attribute value of “4” to represent the four day duration. As yet another example, where a resource mapping 164 indicates a resource level of “4” for Actor D performing the “Service Catalog Management” process for the “zSeries Sever” element (e.g., “Service_Catalog_Management+zSeries_Sever_Level=4” for Actor D), the scoping module 130 may determine, based on the resource mapping 164, a resource level of “4” for Actor D performing the “Service Catalog Management” process for the “zSeries Sever” element, and, in turn, populate the corresponding cell of the P-E pair 186 with the attribute value of “4”. A similar process may be performed for each of the P-E pair 186 to populate the P-E matrix 180.

In some embodiments, a given attribute value is derived from a value of an attribute mapping. For example, where it is desirable to determine expected start or completion dates for P-E pairs 186, duration values may be used to determine expected start or completion dates for the P-E pairs 186, and the cells of the associated the P-E matrix 180 may be populated with an indication of the expected start or completion dates. Referring to FIG. 6B, for example, where the associated outsourcing project is scheduled to commence on Oct. 1, 2023, a duration for each of the P-E pairs 186 may be determined and added to the commencement date to determine an estimated start or completion date for each of the respective P-E pairs 186, and the cells for the P-E pairs 186 may be populated with an indication of the associated estimated start or completion date. In the illustrated embodiment, for example, a timeframe mapping 604 is provided that indicates four respective timeframes for completion. Where a temporal mapping 162 indicates a duration of “4 days” for Actor D performing the “Service Catalog Management” process for the “zSeries Sever” element (e.g., “Service_Catalog_Management+DBMS_Duration=30 days” for Actor D), the scoping module 130 may determine, based on the temporal mapping 162, a duration of 30 days for Actor D performing the “Service Catalog Management” process for the “DBMS” element, determine, based on the 30 days, an estimated target/completion date of Nov. 1, 2023, and determine an associated indicator of “B” for the associated P-E pair 186 based on the timeframe mapping 604, and, in turn, populate the corresponding cell of the P-E pair 186 with the attribute value of “B” to indicate an estimated target/completion date of Nov. 1, 2023. A similar process may be performed for each of some or all of the P-E pairs 186 to populate the P-E matrix 180.

In some embodiments, a scoping model 170 is generated based on relevant historical scoping data. For example, a scoping model 170 may be trained based on a scoping training dataset 144 that includes sets of historical scoping parameters 150, corresponding sets of historical scope models 170 generated based on the sets of historical scoping parameters 150, or the like. In some embodiments, a scoping model 148 is employed to generate a scope model 170 based on a set of scoping parameters 150. For example, where an outsourcing client 104 desires to generate a scope model 170 for use in defining parameters for outsourcing tasks to one or more third parties (e.g., one or more outsourcing providers 106), the outsourcing client 104 may provide scoping parameters (e.g., structured or unstructured data) 150 defining requirements for the outsourcing, and the scoping module 130 may apply the scoping parameters 150 to a “trained” scoping model 148 (e.g., a scoping model trained based on sets of historical scoping parameters 150, corresponding sets of historical scope models 170 generated based on the sets of historical scoping parameters 150, or the like), to generate a corresponding scope model 170 defining a matrix 180 of processes 182 and elements 184. In some embodiments, the matrix 180 of the scope model 170 is populated with relevant information, which may include some or all of the process-element pairs 186 being populated with associated actors, and attributes (e.g., based on attribute mappings 146). For example, the scoping module 130 may populate some or all of the cells of the matrix 180 with associated actors, and attributes, based on attribute mappings 146. In some embodiments, the populated scope model 170 is provided for use in implementing an associated outsourcing operation. For example, the scoping module 130 may generate a statement of work (SOW) that incorporates the populated scope model 170 to define tasks, actors, and responsibilities to be performed in an associated outsourcing operation. In such an embodiment, the outsourcing operation may be performed in accordance with outsourcing parameters defined by the scope model 170, including the process, element, and actor assignments defined by the scope model 170.

FIG. 1B is a diagram that illustrates operational aspects of an outsourcing environment 100 in accordance with one or more embodiments. The illustrated embodiment may include, for example, the scoping module 130 generating a scope model 170 (e.g., based on application of scoping parameters 150 to a scoping model 148), generating corresponding sets of element and process definitions 174 and 176 for the scope model 170, and generating a SOW 172 that includes the scope model 170 and the corresponding sets of element and process definitions 174 and 176. The outsourcing client 104 and one or more outsourcing providers 106 may conduct an outsourcing operation in accordance with the SOW 172 (e.g., including executing tasks, such as processes on elements executed by actors, for the target environment 108 in accordance with assignments defined by the scope model 170 and the associated element and process definitions 174 and 176). The scope model 170 may, for example, be trained by the training module 132 based on a scope training dataset 144 that includes historical sets of scoping parameters 150 and corresponding scope models 170 generated therefor. Attributes of a scope model 170, such as maturity, temporal, or resource-level for P-E pairs of the scope model 170, may be generated based on attribute mappings 146, which may be generated and updated by the monitoring module 134 based on monitoring data 152, such as feedback relating to outsourcing performance.

In some embodiments, the scoping module 130 receives, from an outsourcing client 104 or other entity, scoping parameters 150. For example, the scoping module 130 may receive, from an outsourcing client 104 desiring an IT outsourcing operation for an IT target environment 108, a set of scoping parameters 150 that (a) define an IT-type outsourcing project scope (e.g., Project_Type=IT Hardware; IT Infrastructure Software; IT Business Application Software), (b) define the hardware and software infrastructure of the business of outsourcing client 104 (e.g., Hardware=zSeries Server for Mainframe; DASD storage for Mainframe . . . ; Software=Applications for Mainframe; Applications for Client Location . . . ; and Infrastructure_Software=Applications Development for zSeries Mainframe for Mainframe; DBMS for zSeries Mainframe for Mainframe . . . ) and associated processes therefor (e.g., Processes=IT Leadership, IT Governance . . . ), (c) a listing of the types of processes or specific processes that the outsourcing client 104 is interested in outsourcing (e.g., Processes_for_Outsourcing=Service Catalog Management, Knowledge Management, Infrastructure Architecture Development . . . ), and (d) a listing of one or more candidate outsourcing providers 106 (e.g., Actors=A, B, C, D, E, F, G, H), their respective capabilities (e.g., Actor A=Mainframe as a Service Actor; Actor D=IT Service Management Actor . . . ), or the like.

In response to receiving the scoping parameters 150, the scoping module 130 may perform a scoping process that includes feeding the scoping parameters 150 to a scoping model 148 that is trained to generate a scope model 170 based on a set of scoping parameters 150. The scoping model 148 may, in turn, output a corresponding scope model 170 that includes a hardware scope model for IT (e.g., the same or similar to scope model 170a of FIG. 6A), an infrastructure software scope model for IT (e.g., the same or similar to that of scope model 170b of FIG. 6B), and a business application software scope model for IT (e.g., the same or similar to scope model 170c of FIG. 6C). Such a scoping process may include determining, for each of some or all of the P-E pairs 186 for the scope models 170 generated, a corresponding role (e.g., Client, Mainframe as a Service Actor, or the like), a corresponding actor (e.g., Actor A, Actor B, or the like), or corresponding attribute (e.g., a maturity, temporal, resource level, or the like), and populating the cell for the respective P-E pairs 186 of the process-element matrix 180 of the scope model 170 to indicate the corresponding role, actor, or attribute.

In response to receiving the scope model 170, the scoping module 130 may determine the set of processes contained in the scope model 170. This may include determining processes corresponding to the various processes 182 of the hardware scope model for IT, the infrastructure software scope model for IT, and the business application software scope model for IT, such as “IT Leadership,” “IT Governance,” and so forth (see, e.g., the processes 182 of the scope models 170a, 170b, and 170c of FIGS. 6A-6C). The scoping module 130 may then determine, based on the process definition mapping 142, a respective process definition for each of the determined processes corresponding to the various processes 182, and assemble the determined process definitions into a set of process definitions 176 for the scope model 170, which may be the same or similar to that of process definitions 176 of FIG. 7.

In response to receiving the scope model 170, the scoping module 130 may determine the set of elements contained in the scope model 170. This may include determining elements corresponding to the various elements 184 of the hardware scope model for IT, the infrastructure software scope model for IT, and the business application software scope model for IT, such as “zSeries Sever”, “DASD”, and so forth (see, e.g., the elements 184 of the scope models 170a, 170b, and 170c of FIGS. 6A-6C). The scoping module 130 may then determine, based on the element definition mapping 140, a respective element definition for each of the elements corresponding to the various elements 184, and assemble the determined element definitions into a set of element definitions 174 for the scope model 170, which may be the same or similar to element definitions 174 of FIG. 8.

The scoping module 130 may, in turn, generate a SOW 172 that includes the scope model 170, including the hardware scope model for IT (e.g., the same or similar to the hardware scope model 170a of FIG. 6A), the infrastructure software scope model for IT (e.g., similar to the infrastructure software scope model 170b of FIG. 6B), the business application software scope model for IT (e.g., the same or similar to the business application software scope model 170c of FIG. 6C), the set of process definitions 176 for the scope model 170 (e.g., the same or similar to process definitions 176 of FIG. 7) and the set of element definitions 174 for the scope model 170 (e.g., the same or similar to element definitions 174 of FIG. 8). The SOW 172 may be employed by the outsourcing client 104 (e.g., Actor A) and one or more outsourcing providers 106 (e.g., Actors B-H) to inform the parties as to the details of the outsourcing project, including the associated processes, elements, actor assignments, and associated attributes thereof. The SOW 172 may, for example, serve as a contractual agreement between the outsourcing client 104 and one or more outsourcing providers 106.

In some embodiments, the scoping module 130 provides the scoping parameters 150 and the generated scope model 170 to the training module 132, which, in turn, updates the scoping parameters 150 and scoping models 170 of the scope training dataset 144 to include, or otherwise reflect the scoping parameters 150 and the generated scope model 170. The training module 132 may, for example, generate a “first” scoping model 148 based on an initial scope training dataset 144, and generate a “second” (or “updated”) scoping model 148 based on an “updated” scope training dataset 144 that includes the scoping parameters 150 and the generated scope model 170 discussed above. The scoping module 130 may employ the “first” scoping model 148 to generate a “first” scope model 170, employ the “second” scoping model 148 to generate a “second” scope model 170, and so forth. Such an embodiment may provide an efficient and effective feedback loop that provides for continual training and updating of the scoping model 148.

In some embodiments, the monitoring module 134 collects monitoring data 152 and provides corresponding updates to attribute mapping 146. For example, the monitoring module 134 may collect, from the outsourcing client 104, one or more of the outsourcing providers 106, or other sources, feedback-type monitoring data 152 that includes and provides corresponding updates to attribute mapping 146 that are indicative of performance of associated aspects of implementation of the scope model 170, such as maturity feedback including scoring of the actual performance of actors, temporal feedback that is indicative of the actual amount of time required to complete various processes, and resource feedback that indicative of the actual amount of resources required to complete various processes, or the like. The monitoring module 134 may, in turn, update the maturity mapping 160 to incorporate or otherwise reflect the maturity feedback (e.g., increasing or decreasing maturity scores for actors based on feedback for the actors), update the temporal mapping 162 to incorporate or otherwise reflect the temporal feedback (e.g., increasing or decreasing durations for processes based on feedback for observed process durations), and update the resource mapping 164 to incorporate or otherwise reflect the resource feedback (e.g., increasing or decreasing resource levels for processes based on feedback for observed process resource requirements). Such updating based on monitoring data 152 may provide an efficient and effective mechanism for defining, updating, and communicating attributes of a scope model 170. This may, in turn, provide for efficient and effective assessment, modification, and implementation of a scope model 170 and associated outsourcing operations.

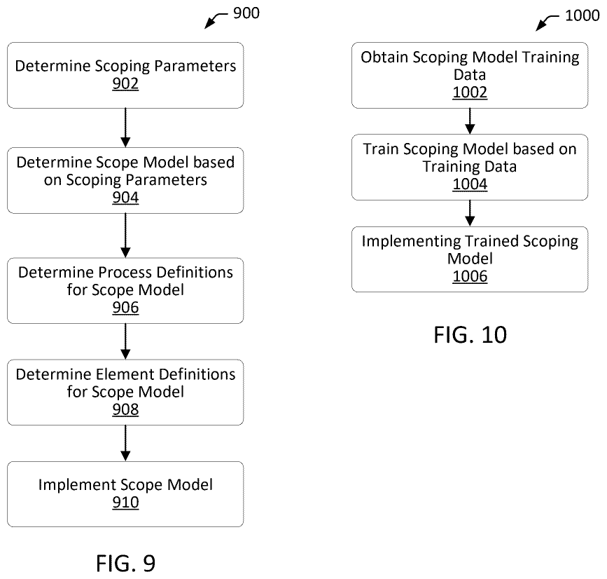

FIG. 9 is a flowchart diagram that illustrates a method 900 of generating and implementing and a scope model in accordance with one or more embodiments. Some or all of the procedural elements of method 900 may be performed, for example, by the scoping module 130 or another entity, such as a person or machine managing the outsourcing process.

Method 900 may include determining scoping parameters (block 902). This may include receiving a set of scoping parameters defining one or more aspects of an outsourcing project. For example, determining scoping parameters may include the scoping module 130 receiving, from an outsourcing client 104 desiring an IT outsourcing operation for an IT target environment 108, a set of scoping parameters 150 that (a) define an IT-type outsourcing project scope (e.g., Project_Type=IT Hardware; IT Infrastructure Software; IT Business Application Software), (b) define the hardware and software infrastructure of the business of outsourcing client 104 (e.g., Hardware=zSeries Server for Mainframe; DASD storage for Mainframe . . . ; Software=Applications for Mainframe; Applications for Client Location . . . ; and Infrastructure Software=Applications Development for zSeries Mainframe for Mainframe; DBMS for zSeries Mainframe for Mainframe . . . ) and associated processes therefor (e.g., Processes=IT Leadership, IT Governance . . . ), (c) a listing of the types of processes or specific processes that the outsourcing client 104 is interested in outsourcing (e.g., Processes_for_Outsourcing=Service Catalog Management, Knowledge Management, Infrastructure Architecture Development . . . ), and (d) a listing of one or more candidate outsourcing providers 106 (e.g., Actors=A, B, C, D, E, F, G, H), their respective capabilities (e.g., Actor A=Mainframe as a Service Actor; Actor D=IT Service Management Actor . . . ), or the like.

Method 900 may include determining a scope model based on scoping parameters (block 904). This may include generating a scope model based on a received set of scoping parameters defining one or more aspects of an outsourcing project. Continuing with the above example, determining a scope model based on scoping parameters may include the scoping module 130 performing a scoping process that includes feeding the scoping parameters 150 to a scoping model 148 that is trained to generate a scope model 170 based on a set of scoping parameters 150. The scoping model 148 may, in turn, generate a corresponding scope model 170 that includes a hardware scope model for IT (e.g., the same or similar to scope model 170a of FIG. 6A), an infrastructure software scope model for IT (e.g., the same or similar to that of scope model 170b of FIG. 6B), and a business application software scope model for IT (e.g., the same or similar to scope model 170c of FIG. 6C). Such a scoping process may include determining, for each of some or all of the P-E pairs 186 for the scope models 170 generated, a corresponding role (e.g., Client, Mainframe as A Service Actor, or the like), a corresponding actor (e.g., Actor A, Actor B, or the like), or corresponding attribute (e.g., a maturity, duration, resource level, or the like), and populating the cell for the respective P-E pairs 186 of the process-element matrix 180 of the scope model 170 to indicate the corresponding role, actor, or attribute.

Method 900 may include determining process definitions for a scope model (block 906). This may include generating a set of process definitions for processes included in a scope model (e.g., based on a process definition mapping). Continuing with the above example, determining process definitions for a scope model may include the scoping module 130 determining the set of processes contained in the scope model 170 and determining a corresponding set of process definitions 176 therefor. This may include the scoping module 130 determining processes corresponding to the various processes 182 of the hardware scope model for IT, the infrastructure software scope model for IT, and the business application software scope model for IT, such as “IT Leadership,” “IT Governance,” and so forth (see, e.g., the processes 182 of the scope models 170a, 170b, and 170c of FIGS. 6A-6C). The scoping module 130 may then determine, based on the process definition mapping 142, a respective process definition for each of the determined processes corresponding to the various processes 182, and assemble the determined process definitions into a set of process definitions 176 for the scope model 170, which may be the same or similar to that of process definitions 176 of FIG. 7.

Method 900 may include determining element definitions for a scope model (block 908). This may include generating a set of element definitions for elements included in a scope model (e.g., based on an element definition mapping). Continuing with the above example, determining element definitions for a scope model may include the scoping module 130 determining the set of elements contained in the scope model 170 and determining a corresponding set of element definitions 174 therefor. This may include the scoping module 130 determining elements corresponding to the various elements 184 of the hardware scope model for IT, the infrastructure software scope model for IT, and the business application software scope model for IT, such as “zSeries Sever”, “DASD”, and so forth (see, e.g., the elements 184 of the scope models 170a, 170b, and 170c of FIGS. 6A-6C). The scoping module 130 may then determine, based on the element definition mapping 140, a respective element definition for each of the elements corresponding to the various elements 184, and assemble the determined element definitions into a set of element definitions 174 for the scope model 170, which may be the same or similar to element definitions 174 of FIG. 8. In some embodiments, AI-based techniques, such as machine learning models, may be employed to generate corresponding set of process or element definitions.

Method 900 may include implementing a scope model (block 910). This may include providing a scope model to parties for use in directing an outsourcing operation or conducting an outsourcing operation in accordance with the scope model. Continuing with the above example, implementing a scope model may include the scoping module 130 generating a SOW 172 that includes the scope model 170, including the hardware scope model for IT (e.g., the same or similar to the hardware scope model 170a of FIG. 6A), the infrastructure software scope model for IT (e.g., similar to the infrastructure software scope model 170b of FIG. 6B), the business application software scope model for IT (e.g., the same or similar to the business application software scope model 170c of FIG. 6C), the set of process definitions 176 for the scope model 170 (e.g., the same or similar to process definitions 176 of FIG. 7) and the set of element definitions 174 for the scope model 170 (e.g., the same or similar to element definitions 174 of FIG. 8). The scoping module 130 may, in turn, provide the generated SOW 172 to parties to the associated outsourcing project, such as the outsourcing client 104 (e.g., Actor A) and one or more outsourcing providers 106 (e.g., Actors B-H). The SOW 172 may be employed by the outsourcing client 104 (e.g., Actor A) and one or more outsourcing providers 106 (e.g., Actors B-H) to inform the parties as to the details of the outsourcing project, including the associated, processes, elements, actor assignments, and associated attributes thereof. The SOW 172 may, for example, serve as a contractual agreement between the outsourcing client 104 and one or more outsourcing providers 106. In some embodiments, the outsourcing operation is conducted in accordance with the SOW 172 and the scope model 170. For example, Actor D (“IT Service Management Actor”) may perform the processes of “Service Catalog Management” and “Knowledge Management” (as defined by process definitions 176 of the SOW 172) for each of the elements 184 (as defined by element definitions 174 of the SOW 172) as specified by the scope models 170a, 170b, and 170c of FIG. 6A-6C, and so forth. As described, in some embodiments, monitoring data 152 may be collected and implemented to update attribute mapping 146.

FIG. 10 is a flowchart diagram that illustrates a method 1000 of training scoping models in accordance with one or more embodiments. Some or all of the procedural elements of method 1000 may be performed, for example, by the training module 132, or another entity, such as a person or machine managing the outsourcing process.

Method 1000 may include obtaining scoping model training data (block 1002). This may include obtaining scoping model training data that is indicative of scoping parameters and associated scoping models generated therefor. For example, obtaining ticketing model training data may include the training module 132 obtaining a scope training dataset 144, which may include historical sets of scoping parameters 150 and associated scoping models 170 generated therefor, or the like.

Method 1000 may include training a scoping model based on training data (block 1004). This may include training a machine learning model based on a corresponding dataset. For example, training a scoping model based on training data may include the training module 132 training the scoping model 148 using scope training dataset 144, including the historical sets of scoping parameters 150 and associated scoping models 170 generated therefor. This may employ AI-based modeling techniques, such as those described here, including techniques employing various machine-learning algorithms.

Method 1000 may include implementing a scoping model (block 1006). This may include employing a scoping model to generate a scope model. For example, implementing a scoping model may include the training module 132 providing the IT scoping model 148 for use in generating a scope model 170 (e.g., as described with regard to block 910 of FIG. 9). As described, such embodiments may provide an efficient and effective feedback loop that provides for training and updating of scoping models 148.

FIG. 11 is a diagram that illustrates an example computer system (or “system”) 1100 in accordance with one or more embodiments. The system 1100 may include a memory 1104, a processor 1106, and an input/output (I/O) interface 1108. The memory 1104 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1104 may include a non-transitory computer readable storage medium having program instructions 1110 stored on the medium. The program instructions 1110 may include program modules 1112 that are executable by a computer processor (e.g., the processor 1106) to cause the functional operations described, such as those described with regard to the entities described (e.g., the management system 102, the outsourcing client 104, or each of some or all of the outsourcing providers 106), or methods 900 and 1000.

The processor 1106 may be any suitable processor capable of executing program instructions. The processor 1106 may include one or more processors that carry out program instructions (e.g., the program instructions of the program modules 1112) to perform the arithmetical, logical, or input/output operations described. The processor 1106 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1108 may provide an interface for communication with one or more I/O devices 1114, such as a joystick, a computer mouse, a keyboard, or a display screen (e.g., an electronic display for displaying a graphical user interface (GUI)). The I/O devices 1114 may include one or more of the user input devices. The I/O devices 1114 may be connected to the I/O interface 1108 by way of a wired connection (e.g., an Industrial Ethernet connection) or a wireless connection (e.g., a Wi-Fi connection). The I/O interface 1108 may provide an interface for communication with one or more external devices 1116, computer systems, servers or electronic communication networks. In some embodiments, the I/O interface 1108 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading by virtue of the way in which those terms are used in other materials incorporated by reference.

What is claimed is:

1. An outsourcing management system comprising:
a sourcing information database comprising:
a process definition mapping; and
an element definition mapping; and
non-transitory computer readable storage medium comprising program instructions stored thereon that are executable by a processor to perform the following operations for outsourcing:
receiving, from an outsourcing client, scoping parameters;
determining, based on the scoping parameters, a scope model comprising a process-element matrix, the process-element matrix comprising:
a set of processes;
a set of elements; and
process-element pairs that each correspond to a respective pair of a process of the set of processes and an element of the set of elements,
each of one or more of the process-element pairs of the process- element matrix populated to identify an actor associated with performing the process associated with the process-element pair for the element associated with the process-element pair, and to identify an attribute associated with the process- element pair;
determining, based on the process definition mapping, a set of process definitions for the set of processes of the scope model;
determining, based on the element definition mapping, a set of element definitions for the set of elements of the scope model; and
generating an outsourcing statement of work comprising:
the populated scope model;
the set of process definitions; and
the set of element definitions.

2. The system of claim 1, wherein the attribute comprises a maturity of the actor for the process-element pair, a duration for the process-element pair, or a resource level for the process-element pair.

3. The system of claim 1, wherein the database comprises an attribute mapping, and wherein the attributes associated with the process-element pairs are determined based on the attribute mapping.

4. The system of claim 3, the operations further comprising:
receiving monitoring data corresponding to attributes associated with the process-element pairs; and
generating, based on the monitoring data, the attribute mapping.

5. The system of claim 1, wherein the database comprises a scoping model trained to determine a scope model based on a set of scoping parameters, and wherein determining the scope model comprises applying the scoping parameters to the scoping model to determine the scope model.

6. The system of claim 5, the operations further comprising training the scoping model based on historical sets of scoping parameters and associated scope models.

7. The system of claim 1, wherein an outsourcing operation is performed in accordance with the outsourcing statement of work.

8. A method of outsourcing management comprising:
receiving, from an outsourcing client, scoping parameters;
determining, based on the scoping parameters, a scope model comprising a process-element matrix, the process-element matrix comprising:
a set of processes;
a set of elements; and
process-element pairs that each correspond to a respective pair of a process of the set of processes and an element of the set of elements,
each of one or more of the process-element pairs of the process-element matrix populated to identify an actor associated with performing the process associated with the process-element pair for the element associated with the process-element pair, and to identify an attribute associated with the process-element pair;
determining, based on a process definition mapping, a set of process definitions for the set of processes of the scope model;
determining, based on an element definition mapping, a set of element definitions for the set of elements of the scope model; and
generating an outsourcing statement of work comprising:
the populated scope model;
the set of process definitions; and
the set of element definitions.

9. The method of claim 8, wherein the attribute comprises a maturity of the actor for the process-element pair, a duration for the process-element pair, or a resource level for the process-element pair.

10. The method of claim 8, wherein the attributes associated with the process-element pairs are determined based on an attribute mapping.

11. The method of claim 10, further comprising:
receiving monitoring data corresponding to attributes associated with the process-element pairs; and
generating, based on the monitoring data, the attribute mapping.

12. The method of claim 8, wherein determining the scope model comprises applying the scoping parameters to a scoping model trained to determine a scope model based on a set of scoping parameters, to determine the scope model.

13. The method of claim 12, further comprising training the scoping model based on historical sets of scoping parameters and associated scope models.

14. The method of claim 8, further comprising performing an outsourcing operation in accordance with the outsourcing statement of work.

15. A method comprising:
determining a scope model comprising a process-element matrix, the process-element matrix comprising:
a set of processes;
a set of elements; and
process-element pairs that each correspond to a respective pair of a process of the set of processes and an element of the set of elements; and
populating one or more of the process-element pairs of the process-element matrix to identify an actor associated with performing the process associated with the process-element pair for the element associated with the process-element pair, and to identify an attribute associated with the process-element pair.

16. The method of claim 15, wherein the attribute comprises a maturity of the actor for the process-element pair, a duration for the process-element pair, or a resource level for the process-element pair.

17. The method of claim 15, further comprising performing an outsourcing operation based on the scope model.

18. A scope model comprising:
a process-element matrix, the process-element matrix comprising:
a set of processes;
a set of elements; and
process-element pairs that each correspond to a respective pair of a process of the set of processes and an element of the set of elements,
one or more of the process-element pairs of the process-element matrix being populated to identify an actor associated with performing the process associated with the process-element pair for the element associated with the process-element pair, and to identify an attribute associated with the process-element pair.

19. The scope model of claim 18, wherein the attribute comprises a maturity of the actor for the process-element pair, a duration for the process-element pair, or a resource level for the process-element pair.
